(19) United States
(12) Patent Application Publication
(10) Pub. No.: US 2005/0000945 A1
(43) Pub. Date: Jan. 6, 2005

(54) Method for producing latticed structures and device for carrying out said method

(76) Inventors: Vladimir Mikhailovich Muraviov, Saratov (RU); Jury Vladimirovich Muraviov, Saratov (RU); Igor Georgievich Ovchinnikov, Saratov (RU)

Correspondence Address: Ilya Zborovsky, 6 Schoolhouse Way, Dix Hills, NY, 11746, US

(21) Appl. No.: 10/494,489

(22) PCT Filed: Jun. 19, 2002
(86) PCT No.: PCT/RU02/00298

(30) Foreign Application Priority Data
Oct. 31, 2001 (RU) 2001129379

(51) Int. Cl. B23K 9/00

(52) U.S. Cl. 219/61; 219/60 R

(57) ABSTRACT

A method of producing grate structures includes forming of a workpiece from elements placed tightly parallel against one another (rods, windings of a spiral or closed rings), their arc winding in a protective atmosphere with seams of a predetermined length locally in predetermined points that determine a character of a pattern of a grate and a strength of connections of elements; a subsequent stretching with a required coefficient. It is possible before stretching to bend the welded wire in a direction which is perpendicular to the placed rods, for example, by rolling and after the stretching to bend the place for obtaining a surface with a double curvature. During stretching it is possible to use auxiliary elements which limit a coefficient of stretching in predetermined regions of the structure for obtaining grate structures of a complicated shape. The device is proposed for automatically producing of flat and volume workpieces of different types of grate structures (FIG. 15) fences, poles, and other small arcitectural forms. The proposed device allows to obtain products in a wound form, which reduces required manufacturing areas, facilitates storage, transportation and allows to irreversibly wind out the structure on situ without a preliminary checking of sizes. The proposed invention allows to exclude the use of transverse connecting elements.

### TECHNICAL FIELD

The invention relates to processing of metals with combined methods, and in particular to welding with subsequent plastic deformation and can be used for making of grates for different use and open-work grate poles from rod material or wire, which can be used as a reinforcement for reinforced concrete and other composition materials, including for producing structures used in seismically dangerous regions, and also as independent carrying and decorative elements.

### PRIOR ART

A method of producing decorative grates of metal strips is known which includes cutting and bending of strips with a given pitch, which are placed one over the other with alternating shift in one side or in the other side relative to the preceding strip, and connecting the strips in places of contact (see patent application RU no. 94012703, IPC B 233 15/12).

A method also known for producing wire nets of low carbon rolled wire material, including operations of supplying longitudinal and transverse rods and their welding (see RU patent no. 664538, IPC B 21 F 27/10).

The above described methods pertain to low technologies and they are labor consuming. The obtained grate occupies large areas, which makes difficult storage and transportation.

A method is known for producing wire, used as a reinforcement for reinforced concrete poles and pipes, over which a spiral of wire (reinforcements) is wound with a given pitch around longitudinal reinforcement rods (SN and P 2.03.01-84 Concrete and Reinforced Concrete Structures P3.22, P5.24). The disadvantage of the method is low technological nature, which makes difficult its automation. In addition, this construction of the grate frame does not allow its use as an independent structural or decorative element. The method does not allow to produce flat grates and grates with surfaces having a double curvature.

A method of producing structural elements of a column type, used for erecting of frame buildings in seismically dangerous areas is known, in which longitudinal and transverse spiral reinforcement is united in a space frame, and the longitudinal spiral reinforcement is placed over the whole length of the construction element and between its convolutions a transverse spiral reinforcement is placed (see RU patent no. 2008411, IPCE 04C3/34). The reinforced frame produced with this method is used for holding pieces of concrete in bound state during the destruction of the reinforced concrete construction as a result of seismic or another action. The disadvantage of the method is the absence of an elastic connection between the spiral elements, which leads to a sharp reduction of carrying capacity of the construction in the case of exceeding a permissible deformation as a result of a seismic or another action, and also in low technological nature of production of the reinforcement frame and impossibility to use the wire frame of this type as an independent structural element.

A method is known for producing reinforcement frames for reinforced concrete columns which includes windings of reinforcing spirals with their subsequent connection by transverse ties-clamps. The spirals are wound with a predetermined pitch with windings having counter current directions, in order to obtain intersection of the convolutions of the neighboring spirals. As a result, a grate structure with the shape of grate cells is obtained, which is close to a rhombic shape. A longitudinal reinforcement is arranged inside the spirals for reliable fixation of the spirals in the projected position (RU patent no. 2059052, IPC E 04C3/34).

The disadvantage of this method is a low technological nature of production of the reinforcing frame and impossibility to use the wire frame of this type as an independent construction. The frames of this type, as a rule are produced directly on a construction site to avoid storage and transportation.

A method for producing frame structures which is the closest to the proposed method includes a parallel laying of longitudinal rods with a small pitch between them, placement in given places of transverse rods (wires) and welding of all points of intersection by means of a contact welding with a subsequent cutting of the transverse rods in predetermined points. With such cuts of the connecting elements, a corresponding pattern of the frame structure is formed. The structure which is obtained as a result of this method makes easier storage and transportation, and on the place of erection the grate is expanded to a desired size. The cells in this process obtain a new shape (U.S. Pat. No. 1,358,101 IPC B 23P 15/12).

The disadvantage of this method is that it is necessary to place, weld and cut the transverse rods in certain points, which makes more difficult the technology of manufacture of the structures and makes difficult its automation. The contact welding of the intersecting rods is critical for the property of the welded surfaces and leads to weakening of the rod in the area of welding, for which expanding structures of thick rods and structures having high stretching coefficient are especially sensitive. In addition, the presence of the transverse connecting elements significantly reduces the static nature of the welded structure. The method does not allow to make structures of more complicated shape, for example grate-shape poles and structures with a surface of double curvature.

An automated line for producing grates is known, which contains means for wire supply, means for producing a frame of the grate including a mechanism for bending of wire, means for its welding, means for removing a deposit and means for supplying a frame of the grate, means for placing of transverse wires, a mechanism for supplying the frame with transverse wires, welding device, a bending device with the cutting mechanism, a device for placement of grates and a chute for finished grates (RU patent 2062676B21 F27/10).

A device for making nets is also known, which includes a welding mechanism with electrodes and a mechanism for stepped movement of the nets mounted on a base. The last mechanism is formed as a beam with catches and pushers, placed on the base with the possibility of a reciprocal movement perpendicular to the axis of supply of transverse rods (RU patent 2020017 B21F 27/10).

These machine tools however are not provided for producing expandable grate structures, composed of tightly placed elements without transverse connecting elements. These machine tools do not allow regulation of a size of the welding seams. All machine tools for welding of grates, have, as a rule, a bin for accumulation of rods or bobbins with supplies of wire in accordance with a number of elements of the base of the finished grate and an additional accumulating element for transverse rods or a bobbin, and also a straightening-cutting device for a transverse element-weft. As a result:
it is necessary to provide significant manufacturing areas for placement of the required number of bobbins or bins-accumulators;
the productivity of the machine tool is reduced due to the increase of the auxiliary time for the labor-consuming alternating (not simultaneous) exchange of the bobbins;
the refuse is increased due to a significant stroke of the carriage, which is equal to the pitch of movement by the cell of the grate since in the event of not sufficient welding through of one or several intersecting elements, and also delay or finishing of the supply of some elements of the base, the plate of the grate is deformed and drawn out as a refuse.

The device for producing pole-shaped frames, mainly for production of reinforced concrete articles includes elements for forming spirals with a predetermined pitch, and also a mechanism for supply, placement and stepped displacement of the transverse carrying (connecting, reinforcing) elements with a subsequent welding with a form spiral in the places of intersection (see RU patent 2008411, IPC E04C3 34; RU patent no. 2059052 IPC E04C3/34).

Since the produced articles have a volume-spacial shape, the machine tool occupies a significant volume and has a very complicated construction.

### DISCLOSURE OF THE INVENTION

The basis for this invention is a task of creating a high technology method for producing grate structures and a device for its implementation, which provide increase of productivity with improvement of quality of produced structures due to improvement of aesthetic and increase of strength characteristics of the structure by means of use of a seam welding in accordance with an original scheme. With the claimed invention it is possible to produce both flat and volume grate structures. The solution of this task is performed by the method and device which exclude the use of transverse connecting elements.

The intended task is resolved in that in the method of producing grate structure, including forming a workpiece from elements, their welding and subsequent stretching with a required coefficient of stretching, wherein in accordance with the invention the elements are placed tightly against one another, a seam welding is performed, for example an arc welding in a protected atmosphere with seams of a predetermined length locally in predetermined points which determine the nature of a pattern of the grate and strength of the connecting elements.

It is advisable to form the flat workpiece from preliminarily straightened rods by their parallel placement.

It is possible, before stretching, to bend the welded workpiece in a direction which is perpendicular to the placed rods, for example by rolling, for producing a surface with a double curvature, and after the stretching to bend tightly for imparting a predetermined shape.

A variant of a volume workpiece is also possible from a ring-shaped elements (windings of a spiral or a set of closed wire rings), and the stretching is performed in an axial direction.

For obtaining shaped structures, the ring-shaped elements can be made with a changing diameter.

For expanding a range of shapes of the grate, it is possible during stretching of the welded workpiece to use limiters of coefficient of stretching in required regions.

In the device for producing grate structures including a base, mechanisms of supply and displacement of elements, a block of welding with welding heads, a control block, in accordance with the present invention the mechanisms of supply and displacement of elements are formed with a possibility of placing the workpieces tightly abutting parallel to one another, while the welding block contains a ramp of supply of a protective gas.

The mechanism or displacement is formed with a possibility of a simultaneous displacement of a welded web over a pitch which is equal to the diameter of the element, the welding heads of the welding block are mounted on a traverse with a possibility of displacement along it, and the welding block is supplied with a joint controlling drive shaft which has slots for supply of a welding wire, wherein each welding head is provided with pressing rollers with an electromagnetic control.

The drive shaft is formed with exchangeable bushings.

The mechanism of supply is combined with a mechanism of displacement in a single block and formed as rolling rollers with the possibility of their mutual displacement which determines a radius of curvature of a ring-shaped element.

The device further has a placement-substrate of a non-ferrous metal.

### BRIEF DESCRIPTION FO THE DRAWINGS

Herein below the proposed invention is explained by concrete examples of implementation with attached drawings in which;

FIG. 1—one of possible schemes of welding of a flat workpiece;

FIG. 2—one of the variants of stretching of the flat workpiece into a grate structure;

FIG. 3—an example of a flat workpiece (welded web) after forming on the rollers;

FIG. 4—an example of a grate with a surface having a double curvature after stretching of the workpiece formed on the rollers;

FIG. 5—a side view of a volume workpiece from spiral elements for a grate open-work pole,

FIG. 6—a top view of the welded volume workpiece from spiral elements for a grate open-work pole;

FIGS. 7 and 8 are fragments of finished grate structures-poles produced with different coefficients of stretching,

FIG. 9—a dependency of force F which is necessary for stretching of a cylindrical pole from a coefficient of stretching k,

FIG. 10—an example of workpiece from windings of spiral with a changing diameter for obtaining an open-work grate pole with a conical shape,

FIG. 11—examples of open-work welded poles with a shape genetrics;

FIG. 12—a general view of a device for producing flat workpieces of grate structures,

FIG. 13—a scheme of a working part of the device for producing flat workpieces,

FIG. 14—a scheme of working part of the device for producing volume workpieces of grate structures,

FIG. 15—examples of finished structures, where
1—elements of a workpiece (rods);
2—welding seams;
3—devices for stretching of a grate;
4—a scheme for applying of forces during stretching of a structure
5—elements of a workpiece (windings of a wire spiral);
6—a base;
7—a mechanism of supply (and also straightening and cutting) of wire to an initial zone;
8—a mechanism of stepped displacement (for example, gripper);
9—a traverse;
10—welding heads;
11—a controlled drive shaft;
12—pressing rollers;
13—a ramp for supply of protective gas;
14—a source of welding current;
15—a control block;
16—an initial zone;
17—a working zone;
18—a zone of welding in the working zone;
19—a placement (substrate);
20—a zone of welded plates;
21—a bobbin (bush) with a welding wire;
22—rolling rollers;
23—guides;
D-a transverse size (diameter) of wire elements of a grate;
H-a pitch of welding along a length of the rod;
L-a width of cells of a stretched grate structure;
F-a force necessary for stretching of the workpiece;
k-a coefficient of stretching equal L/2D.

### BEST VARIANT OF THE INVENTION

For producing grate structures workpieces are formed of elements, which can be rods 1 preliminarily cut or unwound from a roll, windings of a spiral 5 or closed rings. The elements are placed parallel tightly against one another and welded to one another by an arc welding with interrupted seams 2 of a predetermined extension locally in predetermined points, for example, with automatic arc welding in a protective atmosphere (for example, in carbon dioxide medium) in order to form cells of the grate with a required shape and size.

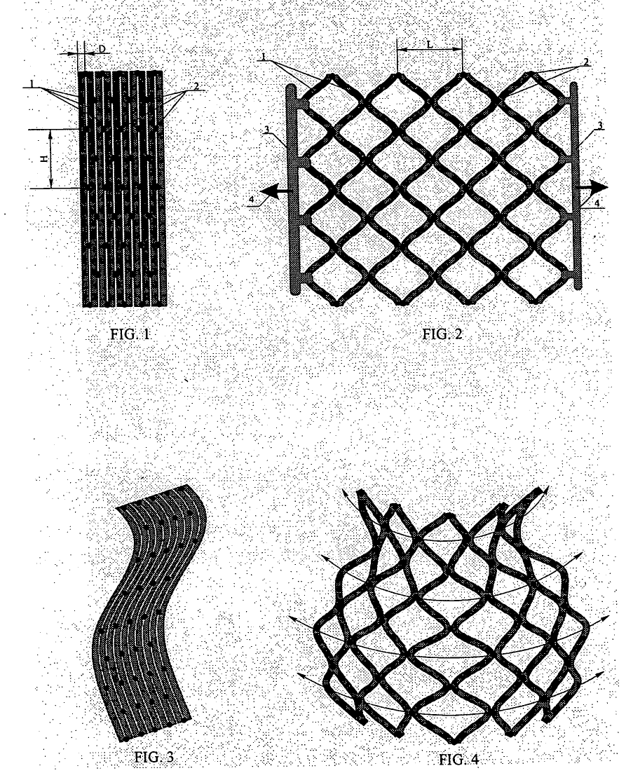

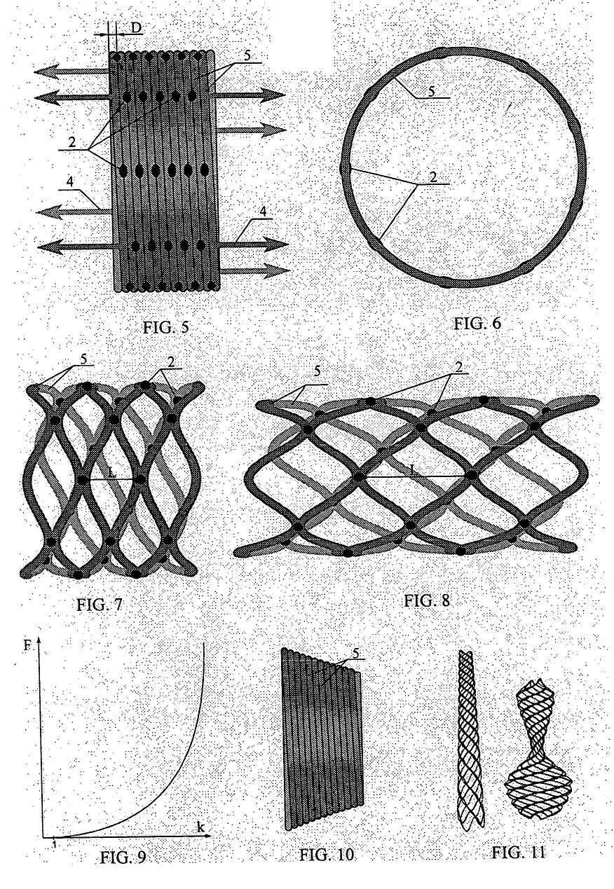

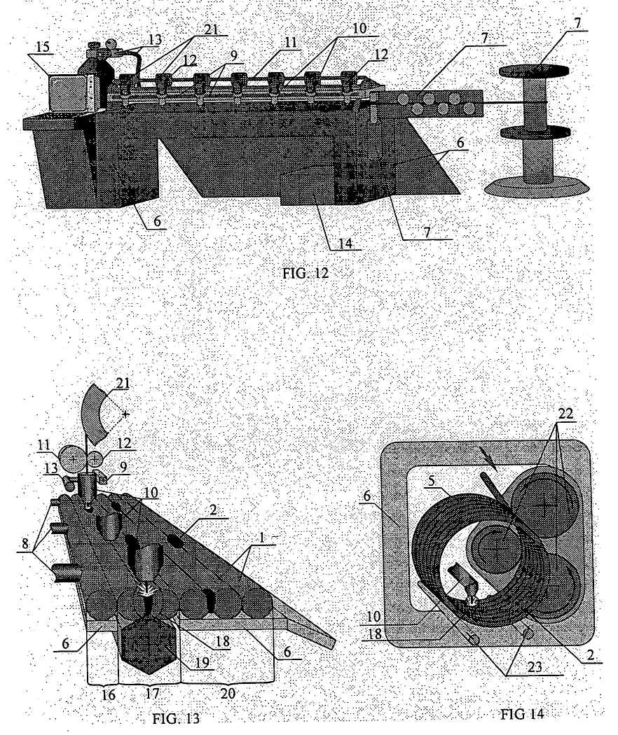

The most technologically sound connection of the elements of grate structures is achieved with a welding by a lower seam “as a boat”. The welding seams have a regular nature, and in the simplest case—such as shown in FIG. 1; 5, wherein H/D=10.50. In a next operation shown in FIG. 2; 5 the side elements of a workpiece are stretched in opposite directions by means of devices for stretching of the grate 3, which can be formed as a jack, a winch, etc. The rods are stretched (FIG. 2) in a direction which is transverse relative to them, and the spirals, rings (FIG. 5) are stretched in an axial direction. All elements which are contained in the grate structure are deformed to the same degree, to form the cells with a shape dependent both on the ratio H/D, and on the ratio L/D, wherein L/D=10 . . . 40.

For producing volume grate structures for example poles, a workpiece is formed from windings of a spiral which are located tightly against one another. It is possible to provide a cylindrical shape of the workpiece (FIG. 5) and a conical shape (FIG. 6), or any other figured shape of the workpiece, including Archimedes. The only limitation for the shape of the forming workpiece composed of windings of a changing diameter is the necessity to place the neighboring windings tightly against one another. During welding of the elements care should be taken to coordinate the shapes of the cells during transition to a next winding, especially for production of poles with a figured generatrix. As a result, a workpiece is obtained which is convenient for storage and transportation.

During stretching of a pole with a figured generatrix (FIG. 10, 11) various portions of the pole have different stiffness, and therefore for obtaining a required geometrical shape of the pole and a predetermined pattern of a grate of which it is composed, it is necessary to limit a coefficient of stretching of the portions with a reduced stiffness. For this purpose, during stretching in required places stiff or elastic auxiliary elements (for example hooks, catches, cable connections) are installed, which limit the coefficient of stretching of the required portions of the figured pole. The above mentioned removable auxiliary elements are necessary only for forming a geometry of the pole during its stretching and they are not a part of the open-work grate pole.

The device for producing flat workpieces of grate structures (FIG. 12) includes a mechanism of wire supply 7 for the case of use of preliminarily straightened rods arranged on the base 6. The device can be additionally provided with a mechanism of straightening and cutting, in the case of supply of a wire from a coil. A mechanism of stepped displacement 8 (for example, a gripper mechanism), a traverse 9 on which welding heads 10 are arranged with the possibility of displacement along the traverse are also arranged on the base. The welding heads 10 have a common controlled drive shaft 11. For supplying a welding wire, ring-shaped grooves can be formed on the shaft, or the shaft can be provided with removable bushings with guiding grooves. The traverse 9 is provided with pressing rollers 12 with an electromagnetic control. The device has a ramp 13 for supply of a protective gas into a working zone of welding. The welding heads are connected to a source of a welding current 14. All mechanisms of the device are connected with a control block 15.

The cut rods of wire are supplied by the supply mechanism 7 into an initial zone 16, and after this by means of the gripper mechanism 8 the rods are supplied to the working zone 17. Depending on the desired shape of cells of the grate, the rods by means of the welding heads 10 are welded with a seam welding locally in predetermined points which determine the nature of the pattern and the strength of the connection. Simultaneously with the process of welding, the supply of next rod in the initial zone 16 is performed. After the end of the welding, the mechanism 8 performs displacement of the supplied rod into the working zone 17, and simultaneous displacement of the welded plate by a pitch which is equal to the diameter of the wire.

The pressing rollers 12 perform pressing of the welding wire to the drive shaft 11, providing the supply of the welding wire into the welding zone 18. Protective gas is supplied into the welding zone by the ramp 13.

The control block 15:
calculates the location of welding points in the plate in accordance with the required pattern of the grate and computes a recommended (nominal) coefficient of stretching of the structure;
performs control of all mechanisms of the machine tool;
performs control of a welding quality with the possibility of correction of welding defects.

The production of grate structures from longitudinal elements which are welded with one another simplifies the technology and increases productivity of automatic production of the structures. The welding of the parallel placed elements “as in a boat” provides a high quality connection of elements of the structure. When it is necessary to produce the structures with great sizes, the possibility of stretching of the welded workpieces in a place of mounting of the structures, allows to make easier their storage and transportation.

The advantages of the device include the absence of cutting knives for the finished plate, since the separation of the plates is performed on the portion of any length with a stepped displacement of the mechanism 8 without turning on of the welding heads.

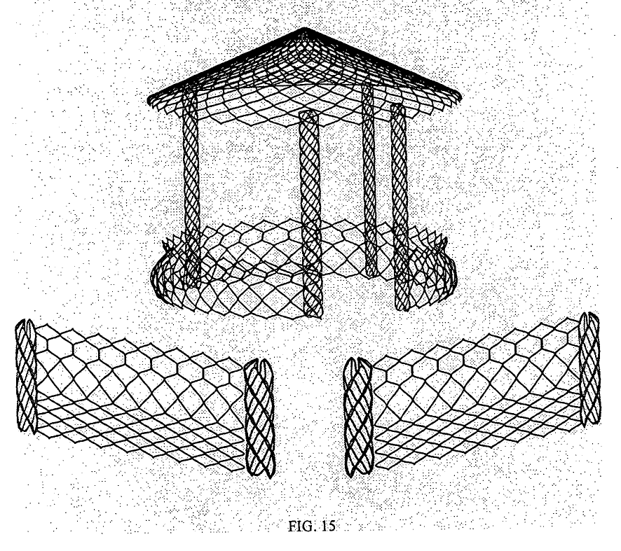

The device for producing volume workpieces of grate structures (FIG. 14) includes a base 6, a welding head 10, a rolling rollers 22, guides 23 for discharge of the welded workpiece.

The device for producing volume workpieces of grate structures (FIG. 14) operates in the following manner. The wire is supplied into the rolling rollers 22 which have a possibility of mutual displacement for providing a required radius of curvature of the ring-shaped elements of the workpiece, for forming a ring-shaped spiral. Simultaneously with the displacement of the wire, a local welding of the neighboring ring-shaped elements in predetermined points is performed. During production of volume workpieces of grate structures from a set of rings, the device additionally contains a mechanism of cutting and forming of a ring-shaped element.

The proposed device allows to obtain products in a wound form, that reduces required manufacturing areas, facilitates their storage, transportation, and allows irreversible winding out of the structure on situ without a preliminary checking of sizes.

### INDUSTRIAL UTILITY

Therefore the invention allows, with minimal expenses of materials, to obtain strong structures which correspond to the static requirements for wide use, both from flat workpieces-grates for fencing, and from volume workpieces-poles-for reinforcement of reinforced concrete structures in seismic of dangerous areas, and also as an energy-absorbing fencing of motorways that significantly increases safety of traffic. The high degree of aesthetics of the produced volume structures significantly expends the area of their use and transforms them into an independent structural, carrying (and/or decorative) element which can be used for creation of small arcitectural forms. The device also allows to expand the assortment of produced articles without retooling and changing of its construction.

1. A method of producing grate structures, including forming of a workpiece from elements, their welding and subsequent stretching with required coefficient of stretching, characterized in that the elements are placed tightly against one another, arc welding is performed in a protected atmosphere with seams of a predetermined length locally in predetermined points, that determine a character of pattern of the grate and the strength of connection of the elements.

2. A method according to claim 1, characterized in that a flat workpiece is formed from preliminarily straightened rods by means of their parallel placement.

3. A method according to claim 2, characterized in that before stretching, a welded workpiece is bent in a direction perpendicular to placed rods, for example by rolling, for producing a surface with a double curvature, and after the stretching it is tightly bent for imparting a predetermined shape.

4. A method according to claim 1, characterized in that a volume workpiece is formed from ring-shaped elements, and a stretching is performed in an axial direction.

5. A method according to claim 4, characterized in that the workpiece is formed from windings of a spiral.

6. A method according to claim 4, characterized in that the workpiece is formed from a set of closed wire rings.

7. A method according to claim 4, characterized in that the ring-shaped elements are formed with a changing diameter.

8. A method according to claims 1, 2, 3, 4, 5, 6, characterized in that during the stretching of a welded workpiece limiters of coefficient of stretching are used in required regions.

9. A device for producing grate structures, including a base, mechanisms for supply and displacement of elements, a welding block, including welding heads, a control block, characterized in that the mechanisms for supply and displacement of the elements are formed with the possibility of placing workpieces tightly against one another, and the welding block includes a ramp for supply of protective gas.

10. A device according to claim 9, characterized in that the mechanism of displacement is formed with the possibility of a simultaneous displacement of a welded plate by a pitch which is equal to a diameter of the element, the welding heads of the welding block are mounted on a traverse with the possibility of displacement on it, and the welding block is provided with a common controlling drive shaft for supply of a welding wire, each welding head is provided with pressing rollers with an electromagnetic control.

11. A device according to claim 10, characterized in that the drive shaft is formed with a replaceable bushings.

12. A device according to claim 11, characterized in that the mechanism of supply is combined with the mechanism of displacement in a single block and formed as rolling rollers with the possibility of their mutual displacement which determines a radius of curvature of a ring-shaped element.

13. A device according to claims 9, 10, 11, 12, characterized in that it additionally includes a placement-substrate of a non-ferrous metal.
